(19) United States
(12) Patent Application Publication
(10) Pub. No.: US 2004/0102224 A1
(43) Pub. Date: May 27, 2004

(54) Method and system of menu browsing for a mobile phone

(76) Inventor: Tai-Hsien Lee, Taipei (TW)

Correspondence Address: RABIN & Berdo, PC, 1101 14TH STREET, NW, SUITE 500, WASHINGTON, DC, 20005, US

(21) Appl. No.: 10/697,882

(22) Filed: Oct. 31, 2003

(30) Foreign Application Priority Data
Nov. 22, 2002 (TW) 91134060
Dec. 2, 2002 (CN) 02156112.5

(51) Int. Cl. G06T 15/00; H04B 1/38; G09G 5/00

(52) U.S. Cl. 455/566; 345/419; 345/700

(57) ABSTRACT

A method and system of menu browsing for a mobile phone is provided. First, an image in a sequence is designated and displayed on a display device of the mobile phone. The designated image corresponds to a menu option. Thereafter, a directional signal is received. Then, a predetermined number of images after or before the designated image in the sequence are displayed in order on the display device according to the signal and sequence, the most recent image is kept to be displayed on the display device, and an option page corresponding to the displayed image on the display device is linked to if a confirmation signal is received.

### BACKGROUND OF THE INVENTION

1. Field of the Invention

The present invention relates to a method and system of menu browsing, and particularly to a method and system of menu browsing for a mobile phone that uses 2D (two-dimensional) figures to simulate the rotation effect of a 3D (three-dimensional) environment, and animated display effects.

2. Description of the Related Art

Convenient mobile communication devices, such as mobile phones, have become enormously popular. With limitations in data processing power and data storage capacity, however, the conventional mobile phones are unable to provide functions of 3D rendering and 3D environment simulation.

### SUMMARY OF THE INVENTION

It is therefore an object of the present invention to provide a method and system of menu browsing for a mobile phone that uses 2D figures to simulate the rotation effect of a 3D environment, and animated display effects.

To achieve the above object, the present invention provides a method of menu browsing for a mobile phone. First, a plurality of images is provided and arranged in sequence, which may be a circular sequence.

Then, one of the images in the sequence is designated and displayed on a display device of the mobile phone, and the designated image corresponds to a menu option.

Thereafter, a directional signal is received. If the directional signal indicates a first direction, a predetermined number of images after the designated image in the sequence are displayed in order on the display device at a preset time interval, and the most recent image is kept to be displayed on the display device. If the directional signal indicates a second direction, the predetermined number of images before the designated image in the sequence are displayed in order on the display device at the preset time interval, and the most recent image is kept to be displayed on the display device. If a confirmation signal is received, an option page corresponding to the displayed image on the display device is linked to.

In addition, an animated image corresponding to the most recent displayed image is further displayed on the display device, and display of the animated image is stopped if another signal is received.

Further, a system of menu browsing for a mobile phone is provided. The system includes a display device, a data storage device, a signal reception device, and a processor.

The data storage device stores a plurality of images arranged in sequence. The processor designates one of the images in the sequence stored in the data storage device to be displayed on the display device. The designated image corresponds to a menu option.

If a signal received by the signal reception device indicates a first direction, the processor displays a predetermined number of images after the designated image in the sequence in order on the display device at a preset time interval, and keeps the most recent image to be displayed on the display device. If the signal received by the signal reception device indicates a second direction, the processor displays the predetermined number of images before the designated image in the sequence in order on the display device at the preset time interval, and keeps the most recent image to be displayed on the display device. If the signal received by the signal reception device is a confirmation signal, the processor links to an option page corresponding to the displayed image on the display device.

In addition, the processor further displays an animated image corresponding to the most recent displayed image on the display device, and stops display of the animated image if another signal is received by the signal reception device.

### BRIEF DESCRIPTION OF THE DRAWINGS

The aforementioned objects, features and advantages of the invention will become apparent by referring to the following detailed description of the preferred embodiment with reference to the accompanying drawings, wherein:

FIG. 1 is a schematic diagram illustrating the architecture of the system of menu browsing for a mobile phone according to the embodiment of the present invention;

FIG. 2 is a flowchart showing the process of the method of menu browsing for a mobile phone according to the embodiment of the present invention; and

FIG. 3 is a schematic diagram illustrating images arranged in a circular sequence.

### DETAILED DESCRIPTION OF THE INVENTION

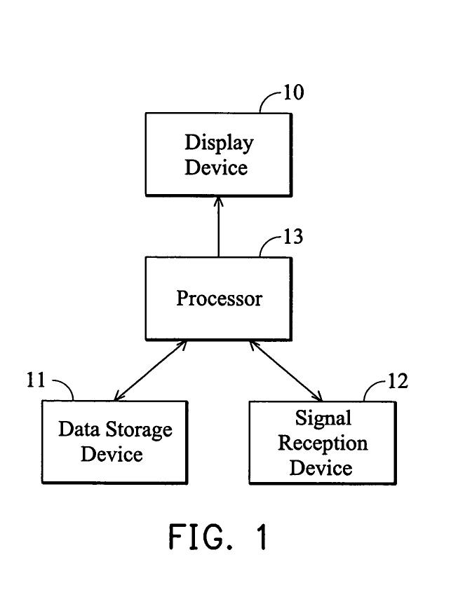

FIG. 1 illustrates the architecture of the system of menu browsing for a mobile phone according to the embodiment of the present invention.

The system according to the embodiment of the present invention includes a display device 10, a data storage device 11, a signal reception device 12, and a processor 13.

The display device 10 may be the screen of the mobile phone. The data storage device 11 stores a plurality of images arranged in sequence. The images may be 3D images, such as images with depth of field, and the images arranged in the sequence can simulate a 360° scene. That is these images can be the images photographed from different angles of the scene, or images corresponding to an object at different angles. These images in the sequence can be linked to form an entire 360° scene. In addition, the signal reception device 12 can be a keyboard of the mobile phone, including the direction and confirmation keys, and CCITT (International Consultative Committee on Telephony and Telegraphy) keys.

When the user enters the menu, the processor 13 designates one of the images in the sequence stored in the data storage device 11 to be displayed on the display device 10. Note that the designated image can be predetermined by the mobile phone system, corresponding to one menu option, such as the functions of address book, phone, voice mail, setup, or others.

If a signal received by the signal reception device 12 indicates a first direction, the processor 13 displays a predetermined number of images after the designated image in the sequence in order on the display device 10 at a preset time interval, such as 0.3 seconds, and keeps the most recent image to be displayed on the display device 10. If the signal received by the signal reception device 12 indicates a second direction, the processor 13 displays the predetermined number of images before the designated image in the sequence in order on the display device 10 at the time interval, and keeps the most recent image to be displayed on the display device 10.

It should be noted that the first direction can, as an example, be the right of the sequence (that is users press the right key to transmit the right signal), and the second direction the left of the sequence (that is users press the left key to transmit the left signal). When a directional signal is received, the purpose of displaying a plurality of sequent images in order is to simulate animation, and the number of images between two images corresponding to respective menu options can be defined by users or the mobile phone system. Of course, from one option to other option, the more the images, the more fluent the animation is.

After the most recent image is kept to be displayed on the display device 10, the processor 13 displays an animated image corresponding to the most recent displayed image on the display device 10. At the same time, the processor 13 stops display of the animated image if another signal is received by the signal reception device 12.

In addition, if the signal received by the signal reception device 12 is a confirmation signal, for example, the user presses the OK key, the processor 13 links to an option page (not shown in FIG. 1) corresponding to the image displayed on the display device 10, and displays the option page on the display device 10 or performs the function corresponding to this option.

It should be noted that the system may further include a FIFO (First In, First Out) queue in which to store the continuous signals input by users. The processor 13 can follow the FIFO rule to perform corresponding operations according to the signals stored in the FIFO queue.

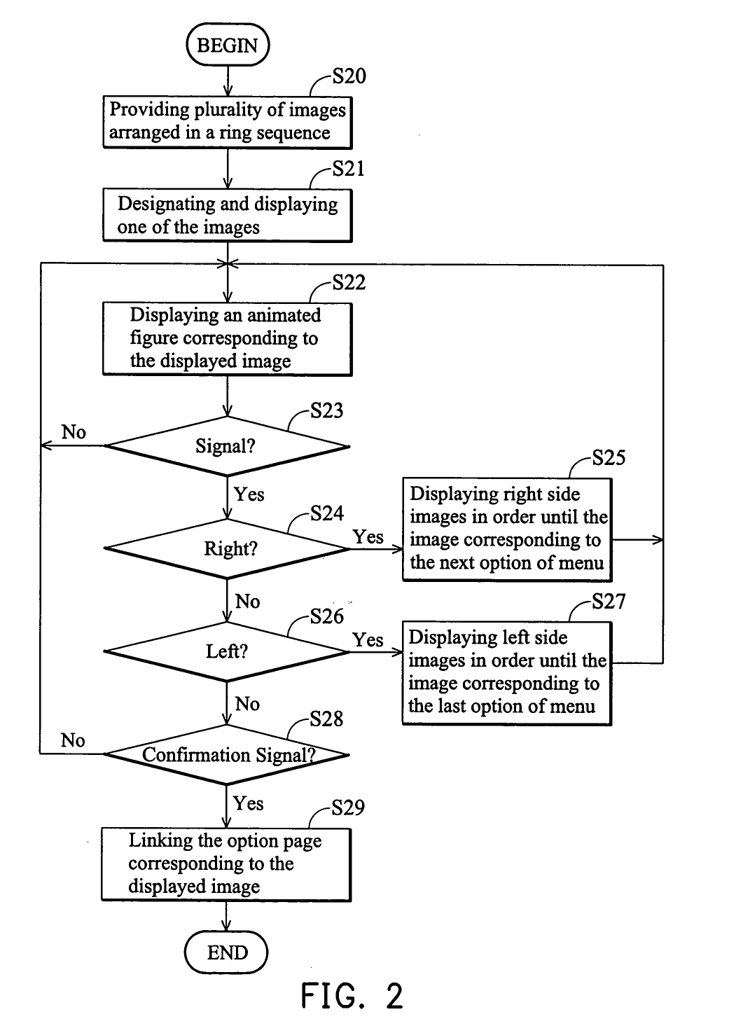

FIG. 2 shows the process of the method of menu browsing for a mobile phone according to the embodiment of the present invention. First, in step S20, a plurality of images arranged in a circular sequence is provided in the mobile phone. Similarly, the images may be 3D images, and the images arranged in the sequence can simulate a 360° scene. In some case, these images can be the images photographed from different angles of the scene, or these images can be images corresponding to an object at different angles.

When the mobile phone enters the menu function, in step S21, the mobile phone system designates and displays one image in the sequence. Note that the designated image can be predetermined by the mobile phone system, corresponding to one menu option, such as the functions of address book, phone, voice mail, setup, or others. Then, in step S22, the mobile phone displays an animated image corresponding to the displayed image.

At the same time, in step S23, the mobile phone system checks whether a signal has been received. If not (No in step S23), the flow returns to the step S22 and continues to be displayed the animated image. If yes (Yes in step S23), in step S24, it is determined whether the received signal is a directional signal indicating right. It should be noted that display of the animated image will be stopped if a signal is received.

If the received signal is a directional signal indicating right (Yes in step S24), in step S25, the mobile phone displays a predetermined number of images after the most recent displayed image in the sequence (images to the right of the most recent displayed image) in order on the display device at a preset time interval, such as 0.3 seconds, and keeps the most recent image to be displayed on the display device. The most recent displayed image corresponds to a following menu option of the mobile phone. After, the flow returns to step S22 and continues to display the animated image corresponding to the currently displayed image. If the received signal is not a directional signal indicating right (No in step S24), in step S26, it is determined whether the received signal is a directional signal indicating left.

If the received signal is a directional signal indicating left (Yes in step S26), in step S27, the mobile phone displays the predetermined number of images before the most recent displayed image in the sequence (the left side images of the most recent displayed image) in order on the display device at the time interval of 0.3 seconds, and keeps the most recent image to be displayed on the display device. The most recent displayed image corresponds to a most recent menu option of the mobile phone. After, the flow returns to step S22 and continues to display the animated image corresponding to the currently displayed image. If the received signal is not a directional signal indicating left (No in step S26), in step S28, it is determined whether the received signal is a confirmation signal.

If the received signal is a confirmation signal (Yes in step S28), in step S29, an option page corresponding to the currently displayed image on the display device is linked to and displayed, and the mobile phone performs the corresponding service. If not (No in step S28), the flow returns to step S22 and continues to display the animated image corresponding to the currently displayed image.

Similarly, the purpose of displaying the plurality of images in order is to simulate animation, and the number of images between two images corresponding to respective menu option can be defined by users or the mobile phone system. The transformation will be smoother if more images are used between the two images corresponding to respective menu options.

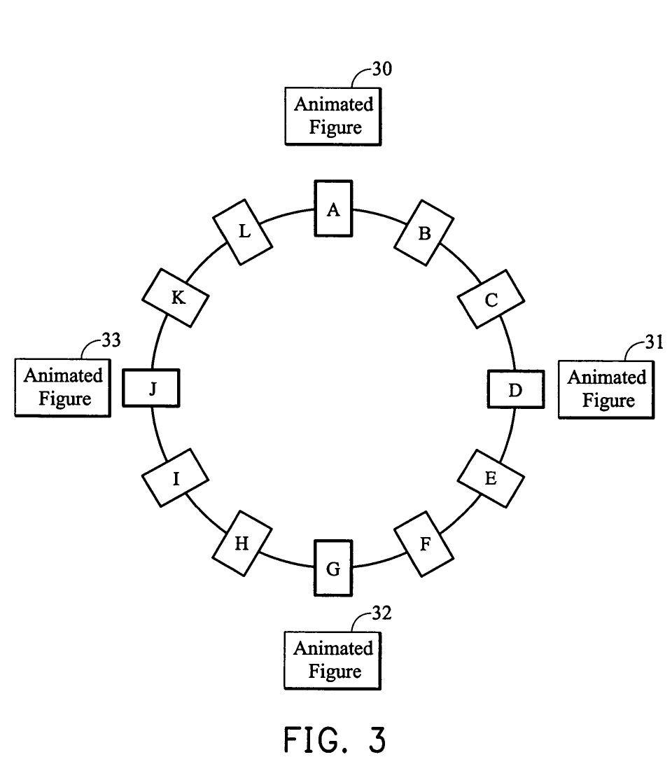

FIG. 3 is a schematic diagram illustrating images arranged in a circular sequence. As shown in FIG. 3, the circular sequence includes 12 images from images A to L. The images A, D, G and J correspond to menu options of the mobile phone respectively, and the images A, D, G and J have corresponding animated images 30, 31, 32 and 33 respectively. The images B and C are transitional images between the images A and D; the images E and F are transitional images between the images D and G; the images H and I are transitional images between the images G and J; and the images K and L are transitional images between the images J and A.

If the initial image of the menu is image A, the mobile phone displays image A and then the corresponding animated image 30 when the mobile phone enters the menu function.

If the mobile phone system receives a directional signal indicating right, the mobile phone displays images B, C, and D (until the image corresponding to the next menu option) in order at the time interval, and displays the animated image 31 corresponding to the image D.

In addition, if the mobile phone system receives a directional signal indicating left (the currently displayed image is image A), the mobile phone displays images L, K, and J (until the image corresponding to the most recent menu option) in order at the time interval, and displays the animated image 33 corresponding to the image J. At the same time, if a confirmation signal is received, the mobile phone system links to an option page corresponding to the image J, and performs the corresponding service.

As a result, using the method and system of menu browsing for a mobile phone according to the present invention, the mobile phone can use 2D figures to simulate the rotation effect of a 3D environment, and provide animated display.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system of menu browsing for a mobile phone, comprising:
a display device;
a data storage device having a plurality of 3D images arranged in sequence, the 3D image corresponding to menu options of the mobile phone;
a signal reception device to receive a signal; and
a processor to perform menu browsing operations, comprising the steps of:
designating one of the 3D images;
displaying a predetermined number of 3D images after the designated 3D image in order on the display device if the signal received by the signal reception device indicates a first direction;
displaying the predetermined number of 3D images before the designated 3D image in order on the display device if the signal received by the signal reception device indicates a second direction.

2. The system of menu browsing for a mobile phone as claimed in claim 1 wherein the processor further perform the steps of:
performing function of the menu option corresponding to the displayed 3D image on the display device if the signal received by the signal reception device is a confirmation signal.

3. The system of menu browsing for a mobile phone as claimed in claim 1 wherein the sequence is a circular sequence.

4. The system of menu browsing for a mobile phone as claimed in claim 1 wherein the processor further displays an animated image corresponding to the most recent displayed 3D image on the display device.

5. The system of menu browsing for a mobile phone as claimed in claim 4 wherein the processor stops displaying the animated image if another signal is received by the signal reception device.

6. The system of menu browsing for a mobile phone as claimed in claim 1 wherein the 3D images arranged in the sequence compose a 360° scene.

7. The system of menu browsing for a mobile phone as claimed in claim 1 wherein the 3D images are images with depth of field.

8. The system of menu browsing for a mobile phone as claimed in claim 1 wherein the display device is the screen of the mobile phone.

9. A method of menu browsing for a mobile phone, comprising the steps of:
providing a plurality of 3D images arranged in sequence, the 3D image corresponding to menu options of the mobile phone; designating one of the 3D images, and displaying the designated 3D images on a screen of the mobile phone t;
receiving a signal;
displaying a predetermined number of 3D images after the designated 3D image in order on the display device if the signal indicates a first direction;
displaying the predetermined number of 3D images before the designated 3D image in order on the display device if the signal indicates a second direction.

10. The method as claimed in claim 9 further comprise the steps of:
linking an option page corresponding to the displayed 3D image on the display device if the signal received by the signal reception device is a confirmation signal.

11. The method of menu browsing for a mobile phone as claimed in claim 9 wherein the sequence is a circular sequence.

12. The method of menu browsing for a mobile phone as claimed in claim 9 further displaying an animated image corresponding to the most recent displayed 3D image.

13. The method of menu browsing for a mobile phone as claimed in claim 12 further stopping display of the animated image if another signal is received.

14. The method of menu browsing for a mobile phone as claimed in claim 9 wherein the 3D images arranged in the sequence compose a 360° scene.

15. The method of menu browsing for a mobile phone as claimed in claim 9 wherein the 3D images are images with depth of field.

16. A system of menu browsing for a mobile phone, comprising:
a display device;
a data storage device having a plurality of 3D images arranged in a circular sequence, the 3D image corresponding to a plurality of menu options of the mobile phone;
a signal reception device to receive a signal; and
a processor to perform menu browsing operations, comprising the steps of:
designating one of the 3D images;
displaying a predetermined number of 3D images after the designated 3D image in the circular sequence in order on the display device if the signal received by the signal reception device indicates a first direction;
displaying the predetermined number of 3D images before the designated 3D image in the circular sequence in order on the display device if the signal received by the signal reception device indicates a second direction; and
performing function of the menu option corresponding to the displayed 3D image on the display device if the signal received by the signal reception device is a confirmation signal.
